(19) United States
(12) Patent Application Publication
(10) Pub. No.: US 2025/0103360 A1
(43) Pub. Date: Mar. 27, 2025

(54) EXTENDING SYNCHRONOUS CIRCUIT DESIGNS OVER ASYNCHRONOUS COMMUNICATION LINKS UTILIZING A TRANSACTOR-BASED FRAMEWORK

(71) Applicants: Advanced Micro Devices, Inc., Santa Clara, CA (US); Xilinx, Inc., San Jose, CA (US)

(72) Inventors: Ananta S. Pallapothu, Chelmsford, MA (US); Raghukul Bhushan Dikshit, San Jose, CA (US)

(73) Assignees: Advanced Micro Devices, Inc., Santa Clara, CA (US); Xilinx, Inc., San Jose, CA (US)

(21) Appl. No.: 18/472,007

(22) Filed: Sep. 21, 2023

(51) Int. Cl. G06F 9/455

(52) U.S. Cl. CPC G06F 9/455

(57) ABSTRACT

A circuit design emulation system having a plurality of integrated circuits (ICs) includes a first IC. The first IC includes an originator circuit configured to issue a request of a transaction directed to a completer circuit. The request is specified in a communication protocol. The first IC includes a completer transactor circuit coupled to the originator circuit and configured to translate the request into request data. The first IC includes a first interface circuit configured to synchronize the request data from an originator clock domain to a transceiver clock domain operating at a higher frequency than the originator clock domain. The first IC includes a first transceiver circuit configured to convey the request data over a communication link that operates asynchronously to the originator clock domain.

### TECHNICAL FIELD

This disclosure relates to integrated circuits (ICs) and, more particularly, to extending synchronous circuit designs over asynchronous communication links using a transactor-based framework.

### BACKGROUND

Some emulation systems use multiple integrated circuits (ICs) to provide in-circuit emulation of circuit designs. Often, the ICs are programmable ICs such as Field Programmable Gate Arrays or “FPGAs.” In other cases, the ICs may be more complex Systems-on-Chips (SoCs). Silicon components of the circuit design to be emulated may be synthesized and mapped to equivalent hardware resources on the ICs of the emulation system. In most cases, since the circuit design does not fit within a single IC for purposes of emulation, the circuit design is partitioned for implementation across the multiple ICs of the emulation system. In a typical SoC circuit design being emulated by an emulation system, for example, there may be thousands of nets that cross between ICs of the emulator system post-partitioning.

Typically, each IC of the emulation system shares inputs/outputs (I/Os) with multiple other ICs. The ICs of the emulation system typically connect via Select I/Os in a mesh architecture. There are fewer available Select I/Os than partitioned or cut nets that must cross IC boundaries in the emulation system. To accommodate the number of nets that must cross between ICs to emulate the circuit design, the data from the nets is time division multiplexed before being transmitted from one IC to another. This process is referred to as “pin-multiplexing” or “pin-muxing.” The speed of the emulation clock, in reference to the clock used to clock the circuitry being emulated in the IC, is reduced to match the multiplexing ratio. In general, the higher the multiplexing ratio, the lower the frequency of the emulation clock.

Available emulation systems utilize Select I/O to transmit cycle accurate data between ICs. Select I/O is limited in its ability to scale with size and transistor counts of circuit designs. One consequence is that Select I/O imposes a bottleneck on emulation performance where increased multiplexing ratios lead to lower emulation clock frequencies. The I/O limitations of ICs also adversely impact performance of the implementation tools as the amount of time needed to achieve a viable partitioning and implementation of the circuit design across the ICs of the emulation system may be significant. Ever increasing circuit design size exacerbates these inefficiencies.

### SUMMARY

In one or more example implementations, a circuit design emulation system having a plurality of integrated circuits includes a first integrated circuit. The first integrated circuit includes an originator circuit configured to issue a request of a transaction directed to a completer circuit. The request is specified in a communication protocol. The first integrated circuit includes a completer transactor circuit coupled to the originator circuit and configured to translate the request into request data. The first integrated circuit includes a first interface circuit configured to synchronize the request data from an originator clock domain to a transceiver clock domain operating at a higher frequency than the originator clock domain. The first integrated circuit includes a first transceiver circuit configured to convey the request data over a communication link that operates asynchronously to the originator clock domain.

The foregoing and other implementations can each optionally include one or more of the following features, alone or in combination. Some example implementations include all the following features in combination.

In some aspects, the first interface circuit includes a transmit first-in-first-out memory configured to synchronize the request data and a receive first-in-first-out memory configured to synchronize response data received in response to the request.

In some aspects, the first transceiver circuit is configured to stream the request data over the communication link.

In some aspects, the communication link is a serial communication link.

In some aspects, the request includes a plurality of transfers and the completer transactor circuit generates the request data by concatenating each transfer of the plurality of transfers.

In some aspects, the request data is conveyed over the communication link in response to translating an entirety of the request into the request data and determining that the first transceiver circuit is ready to accept the request data for conveyance over the communication link.

In some aspects, the emulation system includes a second IC. The second IC includes a second transceiver circuit configured to receive the request data over the communication link. The second IC includes a second interface circuit configured to synchronize the request data from the transceiver clock domain to a completer clock domain operating at a lower frequency than the transceiver clock domain. The second IC includes an originator transactor circuit coupled to the second interface circuit and configured to translate the request data into the request specified in the communication protocol.

The completer circuit is configured to generate a response to the request. The response is specified in the communication protocol.

In some aspects, the originator transactor circuit is configured to convert the response specified in the communication protocol into response data. The second interface circuit is configured to synchronize the response data from the completer clock domain to the transceiver clock domain. The second transceiver circuit is configured to send the response data, as synchronized, over the communication link.

In some aspects, the second interface circuit includes a receive first-in-first-out memory configured to synchronize the request data and a transmit first-in-first-out memory configured to synchronize the response data.

In some aspects, the response data is conveyed over the communication link in response to translating an entirety of a plurality of transfers of the response into the response data and determining that the second transceiver circuit is ready to accept the response data for conveyance over the communication link.

In some aspects, the first transceiver circuit is configured to receive the response data via the communication link. The first interface circuit is configured to synchronize the response data from the transceiver clock domain to the originator clock domain. The completer transactor circuit is configured to translate the response data into the response specified using the communication protocol and provide the response as translated to the originator circuit.

In some aspects, the circuit design is subdivided into a plurality of partitions. Each partition may be implemented in a different integrated circuit of the plurality of integrated circuits by operation of the completer transactor circuit and an originator transactor circuit disposed on opposite ends of the communication link.

In some aspects, a first partition of the plurality of partitions and a second partition of the plurality of partitions are separated along a boundary determined based on inclusion of a communication bus within a signal path coupling the originator circuit and the completer circuit.

In one or more example implementations, a method of emulating a circuit design includes receiving, from an originator circuit disposed in a first integrated circuit, a request of a transaction. The request is specified using a communication protocol of the originator circuit. The method includes translating, by a completer transactor circuit, the request into request data and conveying, by a first transceiver circuit, the request data over a communication link to a second integrated circuit. The method includes translating, by an originator transactor circuit, the request data as received over the communication link into the request specified using the communication protocol. The method includes conveying the request specified in the communication protocol over the communication link to a completer circuit disposed in the second integrated circuit. The communication link operates asynchronously to the originator circuit and to the completer circuit.

The foregoing and other implementations can each optionally include one or more of the following features, alone or in combination. Some example implementations include all the following features in combination.

In some aspects, the request includes a plurality of transfers and the completer transactor circuit generates the request data by concatenating each transfer of the plurality of transfers.

In some aspects, the request data is conveyed over the communication link in response to translating an entirety of the plurality of transfers of the request into the request data and determining that a transceiver circuit of the first integrated circuit is ready to accept the request data for conveyance over the communication link.

In some aspects, the method includes, prior to the conveying the request data over the communication link to the second integrated circuit, synchronizing the request data from an originator clock domain to a transceiver clock domain.

In some aspects, the method includes, subsequent to the conveying the request data over the communication link to the second integrated circuit and prior to the translating the request data as received over the communication link into the request specified using the communication protocol, synchronizing the request data from the transceiver clock domain to a completer clock domain.

In some aspects, the method includes receiving, from the completer circuit, a response of the transaction. The response is specified using the communication protocol. The method includes translating the response into response data and conveying the response data over the communication link to the first integrated circuit. The method includes translating the response data as received over the communication link into a response specified using the communication protocol of the originator circuit. The method includes conveying the response to the originator circuit in the communication protocol.

In some aspects, the response includes a plurality of transfers and the originator transactor circuit generates the response data by concatenating each transfer of the plurality of transfers.

In one or more example implementations, a method of implementing a circuit design in an emulation system includes partitioning a circuit design into a plurality of different partitions. The method includes instrumenting the circuit design as partitioned. For example, the instrumenting may include inserting a completer transactor circuit within the partition that includes the originator circuit, inserting an originator transactor circuit within the partition including the completer circuit. The system is further capable of inserting a transceiver circuit within each of the partitions and respective interface circuits. The method includes processing each of the respective partitions of the circuit design through a design flow. The method can include physically realizing the circuit design, as partitioned, in the emulation system. The method also can include emulating the circuit design by/using the emulation system.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

The inventive arrangements are illustrated by way of example in the accompanying drawings. The drawings, however, should not be construed to be limiting of the inventive arrangements to only the particular implementations shown. Various aspects and advantages will become apparent upon review of the following detailed description and upon reference to the drawings.

FIG. 1 illustrates an example system including a plurality of integrated circuits (ICs).

FIG. 2 illustrates another example of the system of FIG. 1.

FIG. 3 illustrates an example architecture for a completer transactor circuit and an interface circuit.

FIG. 4 illustrates an example implementation of an originator transactor circuit and an interface circuit.

FIG. 5 is a block diagram illustrating certain operative features of the system of FIG. 1.

FIG. 6 illustrates a more detailed example implementation of a bridge interface.

FIG. 7 illustrates an example method of operation of a system using the transactor-based framework described within this disclosure.

FIG. 8 illustrates an example method of implementing a circuit design in an emulation system that includes a plurality of ICs.

FIG. 9 illustrates an example implementation of a data processing system.

### DETAILED DESCRIPTION

While the disclosure concludes with claims defining novel features, it is believed that the various features described within this disclosure will be better understood from a consideration of the description in conjunction with the drawings. The process(es), machine(s), manufacture(s) and any variations thereof described herein are provided for purposes of illustration. Specific structural and functional details described within this disclosure are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to integrated circuits (ICs) and, more particularly, to extending synchronous designs over asynchronous communication links using a transactor-based framework. In accordance with the inventive arrangements described within this disclosure, a system including a plurality of ICs may be used to implement and/or emulate a larger circuit design. In one or more example implementations, the system may be an emulation system that is used for prototyping and/or testing a circuit design prior to implementation or fabrication of that circuit design in silicon as an IC. The circuit design may be for a System-on-Chip (SoC) or any of a variety of other types of ICs that are too large to emulate using a single programmable IC.

The plurality of ICs of the system, as used for emulation, may be coupled by, and communicate through, high-speed communication links. The communication links may be asynchronous with respect to the circuit components implemented and/or emulated in the respective ICs of the system. The inventive arrangements described herein improve pre-silicon emulation performance of the circuit design within the emulation system.

In one or more examples, the circuit design to be emulated using the system may be subdivided into a plurality of different partitions. Each partition is implemented in a different one of the plurality of ICs of the system. The circuit design may be subdivided, e.g., partitioned, using an architecturally aware approach that seeks to perform the partitioning at synchronous communication protocol boundaries. To facilitate communication across partitions, transactor circuitry is inserted into the partitions that communicate with one another. The transactor circuitry facilitates communication between originating circuits and completing circuits that are disposed in the different partitions of the circuit design that communicate across partition (e.g., IC) boundaries.

For example, the transactor-based framework described herein is capable of implementing an interface between synchronous portions of the circuit design to tunnel packaged data over one or more high-speed and asynchronous communication links between the different ICs of the system. The high-speed and asynchronous communication links may be implemented by transceiver pairs disposed in different ICs of the system. The inventive arrangements disclosed herein partition the circuit design along communication bus boundaries therein and insert transactor circuitry at the boundaries. The transactor circuitry is capable of communicating using the communication protocol of the communication bus and providing a standardized interface to the transceivers. That is, different transactors are suited for (e.g., implement) different communication protocols and each is capable of providing a standardized interface to a transceiver. Through inclusion of the transactor-based framework, the transceivers may convey (e.g., send) data over the asynchronous communication links while remaining agnostic to the particular types of data conveyed and/or communication protocols used to convey the data on either side, e.g., on opposite sides or ends, of the asynchronous communication links.

Partitioning of the circuit design and use of the transactor-based framework in combination with the transceivers described herein increases the overall performance of the circuit design as implemented in and/or emulated by the system. The partitioning described provides several advantages that contribute to the increased performance. For example, each partition in each different IC of the system may operate at an optimized clock rate for that partition irrespective of the clock rates of other partitions. This allows some partitions to operate faster and unconstrained by slower operating partitions in other ICs of the system while still communicating over the asynchronous communication links at high data rates.

The partitioning also allows the circuit design to be processed through a design flow, e.g., compiled, in less time than would otherwise be the case. The time required to perform synthesis, placement, and routing, for example, may be reduced owing to the fact that each partition may be processed through the design flow, on an individual basis, in less time than the entirety of the circuit design could be processed. As the partitions may be processed independently of one another, the partitions may be processed through the design flow in parallel resulting in less runtime for performing the design flow on the circuit design.

Further aspects of the inventive arrangements are described below with reference to the figures. For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

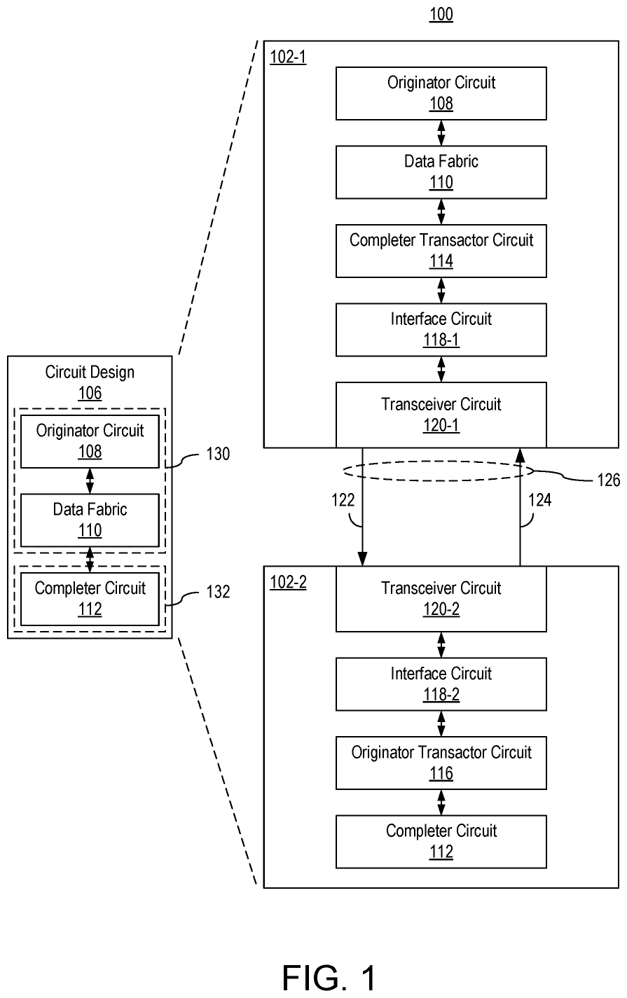

FIG. 1 illustrates an example system 100 including a plurality of Ics. In one or more examples, system 100 is implemented as an emulation system. In the example, system 100 includes IC 102-1 and IC 102-2. For purposes of illustration, IC 102-1 and IC 102-2 may be disposed on the same circuit board and coupled by way of the circuit structures described herein. In another example, IC 102-1 and IC 102-2 may be disposed on different respective circuit boards or in different equipment racks and coupled by way of the circuit structures described herein. It should be appreciated that while only two Ics are illustrated as part of system 100, system 100 may include more than two Ics.

As part of an emulation system, IC 102-1 and IC 102-2 may be implemented as programmable Ics. A programmable IC is an IC that includes at least some programmable circuitry. Programmable logic is a type of programmable circuitry. In this regard, each IC and/or the programmable circuitry therein may be configured to implement different partitions of the circuit design to be emulated. An example of a programmable IC is a Field Programmable Gate Array (FPGA). Other examples of programmable Ics may include any of a variety of different types of Ics, e.g., System-on-Chips (SoCs) and/or Application-Specific Ics (ASICs), that include at least some programmable circuitry.

In the example, circuit design 106 is being developed for fabrication and/or implementation in silicon as an IC. For example, circuit design 106 may be for an ASIC, a programmable IC (e.g., as the IC exists prior to configuration with a user design), and/or an SoC. In the example, circuit design 106 has been subdivided, e.g., partitioned, into a plurality of partitions including partition 130 and partition 132. Each partition may be synthesized, placed, routed, and implemented in a respective IC 102-1, 102-2 of system 100. By virtue of the subdividing, each partition may be implemented independently of the other and optimized independently of the other to obtain the fastest possible operational frequency for the partition. That is, partition 130 may be implemented in IC 102-1 at a first operating frequency while partition 132 may be implemented in IC 102-2 at a second and different operating frequency. Further, the partitions may be processed through a design flow in parallel thereby further reducing the compilation time needed to implement circuit design 106 in system 100.

In the example, circuit design 106 includes an originator circuit 108 connected to a completer circuit 112 through a data fabric 110. For purposes of illustration, originator circuit 108 may be a central processing unit (CPU). Completer circuit 112 may be a memory such as a random-access memory (RAM) coupled to data fabric 110 by way of a memory controller (not shown). Data fabric 110 may be implemented as a type of communication bus. Other examples of communication buses include any of a variety of on-chip interconnect circuitry. FIG. 1 is provided to illustrate various aspects of the inventive arrangements. It should be appreciated that a circuit design implemented in system 100 may be a large circuit design including many more circuit blocks and/or subsystems than illustrated in FIG. 1.

In the example, circuit design 106 is partitioned along the boundary defined by a communication bus, i.e., data fabric 110 in this example. More particularly, circuit design 106 is partitioned between data fabric 110 and completer circuit 112, e.g., a communication interface boundary. As such, originator circuit 108 and data fabric 110 are disposed in partition 130 which is implemented in IC 102-1. Completer circuit 112 is included in partition 132, which is implemented in IC 102-2.

Within an SoC implementation of circuit design 106, e.g., as fabricated post emulation, originator circuit 108, data fabric 110, and completer circuit 112 would be disposed in the same die or in different dies included in a same device or package. Originator circuit 108, data fabric 110, and completer circuit 112 are, and would operate, synchronously with respect to one another. To facilitate the emulation of circuit design 106 by system 100 using different Ics, additional circuitry is included to facilitate partitioning across the different Ics of system 100. More particularly, a transactor-based framework is inserted into circuit design 106 to leverage the capabilities of pairs of transceiver circuits 120 in reference to transceiver circuit 120-1 and transceiver circuit 120-2.

As shown, in IC 102-1, a completer transactor circuit 114 is added and coupled to data fabric 110. An interface circuit 118-1 is added and coupled to completer transactor circuit 114. Transceiver circuit 120-1 is added and coupled to interface circuit 118-1. Within IC 102-2, an originator transactor circuit 116 is added and coupled to completer circuit 112. An interface circuit 118-2 is added and coupled to originator transactor circuit 116. Transceiver circuit 120-2 is added and coupled to interface circuit 118-2.

Transceiver circuits 120 are configured to communicate bi-directionally over communication links 126. In the example, each transceiver circuit 120 operates asynchronously with respect to other circuitry disposed in the same, respective IC. That is, each transceiver circuit 120 may operate at a frequency that differs from the clock frequency of the other components and/or circuit blocks in the same IC. In one or more examples, each transceiver circuit 120 may be implemented using a multi-gigabit transceiver capable of operating at speeds ranging from approximately 500 MHz to 28 GHz while other circuitry operates at slower clock rates. Each transceiver circuit 120 is capable of implementing high-speed communication over communication links 126 illustrated as transmit link 122 and receive link 124. Communication links 126 may be implemented as asynchronous and serial communication links. Each of communication links 126 may be implemented as a differential pair conveying differential signaling.

In the example of FIG. 1, communication links 126 are not cycle accurate. Because of the high-speed operation of communication links 126, transceiver circuits 120 provide increased system performance over other types of input/output (I/O) including Select I/O. Whereas partition 130 and partition 132, if implemented in the same IC would communicate synchronously, in accordance with the inventive arrangements described herein, the two partitions, when implemented in different Ics as shown, communicate asynchronously over communication links 126.

In the example of FIG. 1, originator circuit 108 couples with completer transactor circuit 114. Completer circuit 112 couples with originator transactor circuit 116. Communication between originator circuit 108 and completer circuit 112 may be governed by an originator-completer (e.g., host-device) relationship. As noted, a CPU-memory is an example of such a relationship where the CPU issues requests and the memory issues responses in response to the respective requests. Each request-response pair is referred to as a transaction. For example, a read transaction may include a request for data (e.g., a read request) paired with a response that provides the data (e.g., a read response). A write transaction may include a write request including data to be written paired with a write response indicating successful writing of the data to the memory.

Use of transactor circuitry, e.g., completer transactor circuit 114 and originator transactor circuit 116, facilitates the partitioning of circuit design 106 so partitions 130, 132 may be separated by an asynchronous boundary. In general, each transactor circuit is capable of translating data back and forth between a data structure format suitable for streaming and conveyance through a memory interface and a Register Transfer Level (RTL) signal format that corresponds to a particular communication protocol. For example, each transactor circuit is capable of receiving data (e.g., requests and/or responses) in the form of signals (e.g., RTL signals) from a source circuit, translating the RTL signals into data, storing the data in a memory as a data structure, and outputting the data to another circuit by way of a memory interface. Transactor circuitry is also capable of operating in the reverse. That is, each transactor circuit is capable of receiving data by way of a memory interface, storing the data as a data structure in a memory, and reconstructing the data as signals in conformance with the communication protocol.

Interface circuits 118 are capable of synchronizing data back and forth between different clock domains. For example, interface circuit 118-1 may receive data from completer transactor circuit 114 operating in a clock domain corresponding to originator circuit 108 (e.g., the originator clock domain), synchronize the data to a clock domain of transceiver circuits 120 (e.g., the transceiver clock domain), and convey the data as synchronized to transceiver circuit 120-1. Interface circuit 118-1 also may operate in the reverse. That is, interface circuit 118-1 may receive data from transceiver circuit 120-1, synchronize the data from the transceiver clock domain to the originator clock domain, and convey the data as synchronized to completer transactor circuit 114.

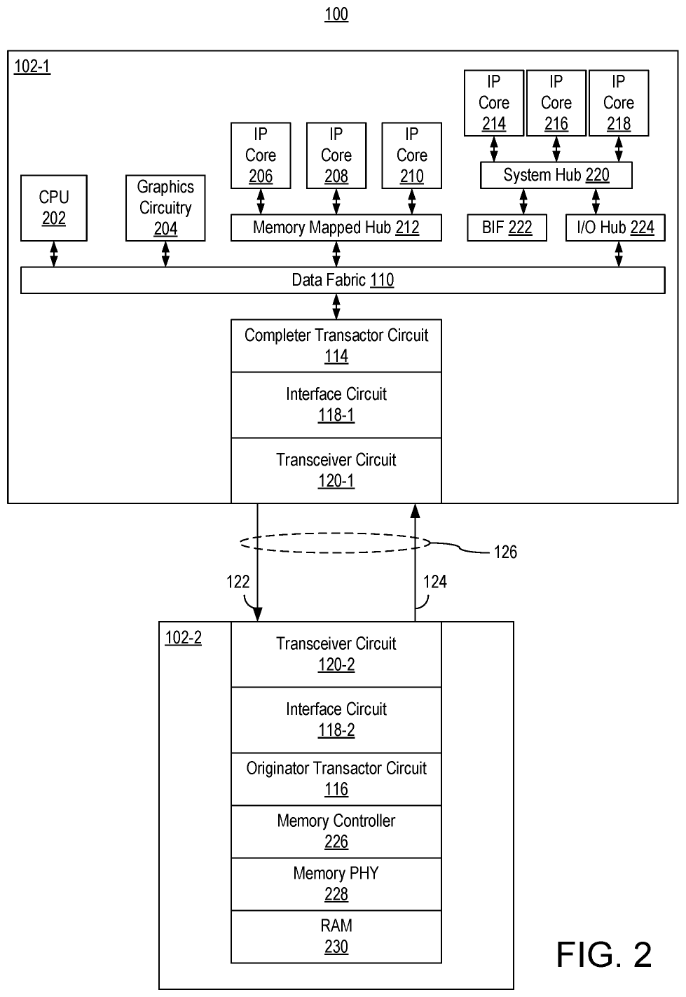

Interface circuit 118-2 may operate in the same or similar manner as interface circuit 118-1. For example, interface circuit 118-2 may receive data from originator transactor circuit 116 operating in a clock domain corresponding to completer circuit 112 (e.g., the completer clock domain), synchronize the data to the transceiver clock domain, and convey the data as synchronized to transceiver circuit 120-2. Interface circuit 118-2 also may operate in the reverse. That is, interface circuit 118-2 may receive data from transceiver circuit 120-2, synchronize the data from the transceiver clock domain to the completer clock domain, and convey the data as synchronized to originator transactor circuit 116. In the examples, depending on the circuit design and implementation, the originator clock domain may operate at the same clock frequency as the completer clock domain, at a higher clock frequency, or at a lower clock frequency. Further details regarding operation of system 100 and the conveyance of data between Ics 102-1 and 102-2 are described in connection with FIG. 2. From time-to-time within this disclosure, different clock domains may be referred to as a first clock domain, a second clock domain, etc. Such reference indicates that the clock domains are separate or independent.

FIG. 2 illustrates another example of system 100. In the example of FIG. 2, the partitions implemented in each of IC 102-1 and IC 102-2 are illustrated in greater detail. For example, originator circuit 108 of FIG. 1 may be implemented as CPU 202. Completer circuit 112 may be implemented as memory controller 226, memory Physical Interface (PHY) 228, and random-access memory (RAM) 230. RAM 230 may be implemented as any of a variety of different types of memory devices. In one or more examples, RAM 230 may be implemented as a Double Data Rate, Synchronous Dynamic Random Access Memory (DDR memory). In one or more examples, RAM 230 may be disposed on IC 102-2. For example, RAM 230 may be implemented as a block RAM as part of device memory. In one or more other examples, RAM 230 may be external to IC 102-2 (e.g., on a same circuit board as IC 102-2 but not part of or within IC 102-2).

In the example, partition 130 as implemented in IC 102-1 may include additional circuit components including, but not limited to, graphics circuitry 204 and a plurality of Intellectual Property (IP) cores 206, 208, and 210 that couple to data fabric 110 by way of a memory mapped hub 212 (e.g., a memory mapped interface). The partition in IC 102-1 may also include IP cores 214, 216, and 218 coupled to data fabric 110 by way of a system hub 220 and an input/output (I/O) hub 224. System hub 220 may be coupled to another bus interface (BIF) 222. Different ones of the IP cores illustrated may function as originator circuits while other ones of the IP cores illustrated may function as completer circuits. It should be appreciated that while not illustrated, IC 102-2 may include one or more additional IP cores and that such IP cores may function as originator circuits while other ones of the IP cores may function as completer circuits.

An “Intellectual Property core” or “IP core” refers to a pre-designed and reusable unit of logic design, a cell, or a portion of chip layout design in the field of electronic circuit design. An IP core may be expressed as a data structure specifying a description of circuitry that performs a particular function. An IP core may be expressed using hardware description language file(s), as a netlist, as a bitstream that programs a programmable IC, or the like. An IP core may be used as a building block within circuit designs adapted for implementation within an IC to specify a particular circuit block or instance of a circuit block.

An IP core may include additional resources such as source code, scripts, high-level programming language models, schematics, documentation, constraints, and the like. Examples of different varieties of IP cores include, but are not limited to, digital signal processing (DSP) functions, memories, storage elements, math functions, processors, etc. Some IP cores include an optimally floorplanned layout targeted to a specific family of Ics. IP cores may be parameterizable in that a user may enter a collection of one or more parameters, referred to as a “parameterization,” to activate or change certain functionality of an instance of an IP core.

As discussed, the partitioning and asynchronous boundary between the partitions as implemented in different Ics allows each partition to operate at a different clock frequency (or different clock frequencies as the case may be) that may be optimized with respect to the particular circuit components in each respective partition. As an illustrative and non-limiting example, CPU 202 may boot a real-time operating system clocked by a faster clock for the partition that permits faster boot times than would be the case were the partition to operate synchronously with the other partition which may have a slower clock frequency. The transactor-based framework described herein provides the control layer glue logic that handles transactions between the two partitions.

In one or more examples within this disclosure, the transactor-based framework may be implemented in whole or in part using programmable circuitry. For example, circuit blocks such as transactor circuits, interface circuits, and/or transceiver circuits may be implemented using programmable circuitry.

In the examples of FIGS. 1 and 2, transactor circuits facilitate the “breaking” of a communication bus across an asynchronous communication link such as communication links 126. That is, an originator circuit and a completer circuit may be separated at a bus boundary (e.g., data fabric 110), partitioned, and placed in different Ics. Transactions are able to flow over the IC boundary. In the example of FIG. 2, CPU 202 may issue a request. The request may be to read data from RAM 230 or to write data to RAM 230.

For purposes of illustration, consider the case where the request is a write request. CPU 202 issues a write request over data fabric 110, which reaches completer transactor circuit 114. In this example, data fabric 110 and CPU 202 communicate using a communication protocol such as the Sockets Direct Protocol (SDP). Completer transactor circuit 114 is configured to communicate over data fabric 110 also using the SDP. That is, completer transactor circuit 114 is capable of receiving signals formatted using the SDP and generate signals formatted using the SDP. Completer transactor circuit 114 is further able to understand transactions (e.g., request and/or responses) as received and conveyed.

Completer transactor circuit 114, being configured to communicate over data fabric 110 with CPU 202, understands the received request and is capable of determining from the request how many individual data transfers are to be received as part of that request. In this case, the request may include multiple different transfers of data conveyed over a plurality of consecutive clock cycles to form the write request. The number of different transfers that form the write request depend on the amount of data to be written and/or the size (width) of the data bus and/or width of completer transactor circuit 114 as coupled to the data bus. Completer transactor circuit 114 determines the number of transfers to be performed as part of the write request from CPU 202.

In one or more examples, completer transactor circuit 114 streamlines the transfers by concatenating the individual transfers thereby converting the request into data (e.g., “request data”). Completer transactor circuit 114 writes the request data to an internal memory as a data structure. An example of a data structure that may be used to store data, whether request data or response data, is an array. Thus, each request originating as signals and each response originating as signals may be stored as a separate and independent data structure (e.g., a separate array).

As an illustrative and non-limiting example, completer transactor circuit 114 is capable of classifying the received beats of data of the request into command beats (e.g., read/write), control credit beats (e.g., read/write), and data beats (if present depending on the request). Completer transactor circuit 114 is capable of creating the array as generated from the various beats of data as classified and make the array available to interface circuit 118-1. Each different type of data may be enumerated or otherwise designated within the array (e.g., the command portion, the control credit portion, and any data portion).

Interface circuit 118-1 is in communication with completer transactor circuit 114. In one or more examples, completer transactor circuit 114 is capable of determining when complete request data, corresponding to the request from CPU 202, is stored in memory. As noted, completer transactor circuit 114, being configured to communicate using the SDP, is aware of the number of individual transfers that need to be received and concatenated to form complete request data. In response to determining that complete request data is stored therein, completer transactor circuit 114 notifies interface circuit 118-1 of the availability of request data.

Interface circuit 118-1 reads request data from the memory of completer transactor circuit 114, synchronizes the request data from the originator clock domain to the transceiver clock domain, and provides the request data to transceiver circuit 120-1 as a data stream. As part of the data transfer function, interface circuit 118-1 is capable of querying transceiver circuit 120-1 to determine whether transceiver circuit 120-1 is ready, e.g., has the capacity to receive data. In response to transceiver circuit 120-1 indicating that data may be received, interface circuit 118-1 conveys the request data from completer transactor circuit 114 to transceiver circuit 120-1 as a data stream.

Transceiver circuit 120-1 is capable of conveying the request data as a data stream over transmit link 122 to transceiver circuit 120-2. In one or more examples, transmit link 122 is implemented as a serial communication link such that transceiver circuit 120-1 conveys the request data as serial data. Thus, transceiver circuit 120-1 is capable of serializing the data to convey the data over transmit link 122. In one or more examples, each of transmit link 122 and receive link 124 is implemented as a one-way communication link that uses differential signaling.

Transceiver circuit 120-2 receives the request data as streamed over transmit link 122 and provides the request data as a data stream to interface circuit 118-2. Interface circuit 118-2 synchronizes the request data from the transceiver clock domain to the completer clock domain and stores the request data within a memory of originator transactor circuit 116 as a data structure (e.g., an array). Originator transactor circuit 116 interprets the request data and generates the necessary signaling (e.g., reconstructs the RTL signals) specified by the request data as understood by memory controller 226 to effectuate the write request as originated from CPU 202. That is, originator transactor circuit 116 converts the request data into one or more individual transfers specified as RTL signals (e.g., the different beats of data as originally received) understood by memory controller 226 to initiate the write operation to RAM 230 over memory PHY 228. In this example, the RTL signaling may conform to the SDP.

A similar process occurs in the reverse direction for providing a response (e.g., a write response) back to CPU 202. The response conveyed from memory controller 226 is provided to originator transactor circuit 116 as one or more transfers received as RTL signals formatted according to, or specified using, the SDP. Originator transactor circuit 116 translates the response into response data that is stored in a memory of originator transactor circuit 116 as a data structure (e.g., an array). For example, originator transactor circuit 116 classifies the different types of beats of data and concatenates the data to form the array as previously described. Originator transactor circuit 116, like completer circuit 112, is configured to communicate using SDP and, as such, is able to determine from the response how many transfers are to be received and concatenated to form complete response data.

In response to determining that complete response data is stored in the memory, originator transactor circuit 116 is capable of notifying interface circuit 118-2 of the availability of the response data. Interface circuit 118-2, in response to the notification, is capable of querying transceiver circuit 120-2 as to whether transceiver circuit 120-2 is ready, e.g., able to receive data. In response to determining that transceiver circuit 120-2 is able to receive data, interface circuit 118-2 synchronizes the response data from the completer clock domain to the transceiver clock domain and provides the response data, as synchronized, to transceiver circuit 120-2.

Transceiver circuit 120-2 conveys the response data as a data stream over receive link 124 to transceiver circuit 120-1. Transceiver circuit 120-2, in conveying the data over receive link 124, serializes the data. Interface circuit 118-1 obtains the streamed response data and synchronizes the response data from the transceiver clock domain to the originator clock domain. Interface circuit 118-1 is capable of storing the streamed response data as synchronized into the memory of completer transactor circuit 114 as a data structure (e.g., an array). Completer transactor circuit 114 converts the response data into a response specified as RTL signals using SDP as specified by the response data structure. The RTL signals, e.g., the beats of data as reconstructed from the response data, are understood by CPU 202 as the expected response.

It should be appreciated that while a write operation is described, other types of transactions may be performed in the same or similar manner. While a write response may include a single transfer, a read response may include a plurality of transfers depending on the amount of data being retrieved. For example, CPU 202 may initiate a read operation from RAM 230 where the request-response pair of the transaction is handled in substantially the same or similar way as the write transaction albeit with the request potentially requiring a single transfer and the response potentially requiring a plurality of transfers. In this regard, whether concatenation is required for a given request and/or response will depend on the amount of data being conveyed.

In the example of FIG. 2, other circuits may operate as originators. For example, IP cores 206, 208, 210, 214, 216, and/or 218 may operate as originator circuits that communicate with respective completer circuits such as memory controller 226 or other completer circuits in IC 102-2. As noted, other ones of the IP cores of IC 102-1 may operate as completer circuits where the corresponding originator circuits are disposed in IC 102-2. For each originator-completer circuit pair, a completer transactor circuit and an originator transactor circuit are implemented as illustrated in the example of FIG. 2 (e.g., where a completer transactor circuit is paired with the originator circuit and an originator transactor circuit is paired with a completer circuit).

It should be appreciated that for each additional originator-completer circuit pair in different partitions (Ics) that communicates using SDP, an additional instance of the completer transactor circuit 114 and of the originator transactor circuit 116 would be inserted. Each transactor circuit instance may be implemented with a same or different configuration. For example, while additional SPD transactor circuits may be implemented, each may be configured for communication with a particular bus and/or configured to use a particular bus width depending on the width of data conveyed by the particular originator-completer circuit pair with which the transactor circuit instances are to operate.

Within this disclosure, SDP is used an example communication protocol. It should be appreciated that other transactor circuits may be used for other originator-completer circuit pairs that communicate using different communication protocols. For example, Peripheral Component Interconnect Express (PCIe) transactor circuits may be used, Advanced Microcontroller Bus Architecture (AMBA) extensible Interface (AXI) transactor circuits may be used, or the like. Each different transactor circuit is configured to understand signaling of a selected communication protocol and translate between the RTL signaling domain using the selected communication protocol and a data domain in which the RTL signaling data is converted into data (e.g., stored as a data structure) as previously described. Accordingly, in the case where transactors are used with IP core 206, 208, 210, 214, 216, and/or 218, a completer transactor circuit and an originator transactor circuit each configured to communicate using the same communication protocol as the particular IP core and the communication bus to which the IP core is connected may be inserted.

For example, in the case where IP core 218 is an originator circuit that communicates with a completer circuit in IC 102-2, a completer transactor circuit may be connected to IP core 218, to system hub 220, or to I/O hub 224. The completer transactor circuit will be of a type that is capable of understanding the particular communication protocol used by the particular communication bus to which the completer transactor circuit connects. The originator transactor circuit implemented in IC 102-2 for the completer transactor circuit used with IP core 218 will be of the same (e.g., matched) type to communicate using the same communication protocol.

In another example, if IP core 218 is a completer circuit that communicates with an originator circuit in IC 102-2, an originator transactor circuit may be connected to IP core 218, to system hub 220, or to I/O hub 224. The originator transactor circuit will be of a type that is capable of understanding the particular communication protocol used by the particular communication bus to which the originator transactor circuit connects. The completer transactor circuit implemented in IC 102-2 for the originator transactor circuit used with IP core 218 will be of the same (e.g., matched) type to communicate using the same communication protocol.

Within the examples of FIGS. 1 and 2, each transactor circuit may implement a standardized memory interface. By including a standardized memory interface, interface circuits 118 and transceiver circuits 120 may be used for any of a variety of different transactions and/or communication protocols so long as transactor circuit pairs are available. The interface circuits 118 and the transceiver circuits 120 may remain agnostic to the data that is conveyed and/or the communication protocol used to convey the transactions among various originator circuit(s) and/or completer circuit(s).

In the example of FIG. 2, a single transactor circuit pair is shown that communicates through a particular pair of transceiver circuits 120. It should be appreciated that communication links 126 are capable of conveying data for a plurality of different transactor circuit pairs. While additional pairs of transceiver circuits may be implemented, each pair of transceivers may communicate data from up to N different transactor circuit pairs, where N is an integer value described in greater detail hereinbelow.

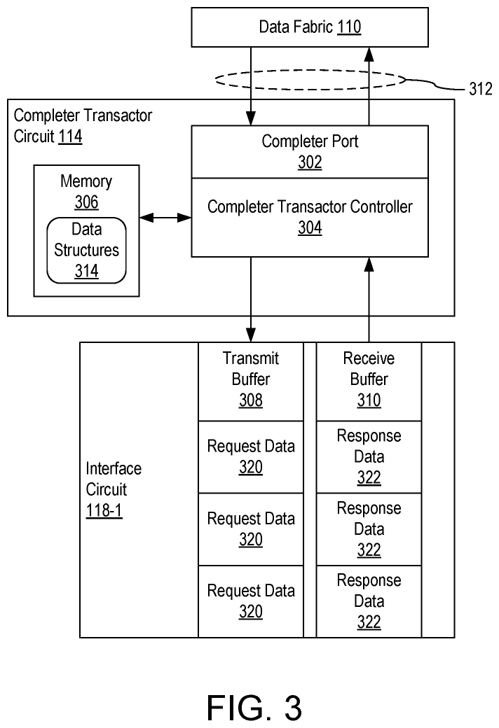

FIG. 3 illustrates an example architecture for completer transactor circuit 114 and interface circuit 118-1. In the example of FIG. 3, completer transactor circuit 114 includes a completer port 302, a completer transactor controller 304, and a memory 306.

Completer transactor circuit 114 is capable of receiving requests of transactions as one or more transfers received over one or more clock cycles via completer port 302 as coupled to data fabric 110. Completer port 302 is a port that supports RTL signaling corresponding to a selected communication protocol used by data fabric 110 and/or originator circuit 108. Though the SDP is used for purposes of illustration, the selected communication protocol may be any of a variety of different communication protocols such as PCIe, AXI, or the like.

In the example of FIG. 3, a request is received via completer port 302. The request is specified as RTL signals 312 formatted in the selected communication protocol. Completer transactor controller 304 translates the received request into request data that is stored in completer transactor memory 306 as a data structure (e.g., shown as data structures 314). Each request and each response may be stored as a distinct data structure. As noted, an example of a data structure that may be used to store request data and/or response data is an array. For example, in the case of a write request, multiple transfers of data may be received via completer port 302 over a plurality of consecutive clock cycles as RTL signals 312 in the selected communication protocol. Completer transactor controller 304 is capable of concatenating each respective transfer into request data (e.g., as a single array) stored in memory 306.

Completer transactor controller 304 is capable of receiving response data streamed from interface circuit 118-1 and storing the streamed response data as a data structure in memory 306. Completer transactor controller 304 reads the response data from memory 306 and converts or reconstructs the response as RTL signals 312 using completer port 302. The response, in the form of RTL signals 312, may be conveyed to CPU 202 over data fabric 110 using the selected communication protocol.

In the example of FIG. 3, completer transactor circuit 114 may be configured to provide a standardized streaming interface to interface circuit 118-1.

In the example of FIG. 3, interface circuit 118-1 includes a plurality of buffer memories. As illustrated, interface circuit 118-1 includes a transmit buffer 308 and a receive buffer 310. Transmit buffer 308 is capable of storing request data 320 obtained from memory 306 corresponding to a plurality of different requests. Transmit buffer 308 may store the request data 320 until such time that transceiver circuit 120-1 is ready to receive the request data 320. In one or more example implementations, transmit buffer 308 and receive buffer 310 each may be implemented as a first-in-first-out (FIFO) memory.

Receive buffer 310 is capable of storing response data 322 corresponding to a plurality of different responses. Receive buffer 310 stores the response data 322 received from transceiver circuit 120-1 before streaming to completer transactor circuit 114 and storing the response data 322 in memory 306 (e.g., as data structures 314).

In the example of FIG. 3, to synchronize data between the transceiver clock domain and the originator circuit clock domain, the data port of transmit buffer 308 coupled to completer transactor circuit 114 and the data port of receive buffer 310 coupled to completer transactor circuit 114 operate in the originator clock domain while the data port of transmit buffer 308 coupled to transceiver circuit 120-1 and the data port of receive buffer 310 coupled to transceiver circuit 120-1 operate in the transceiver clock domain.

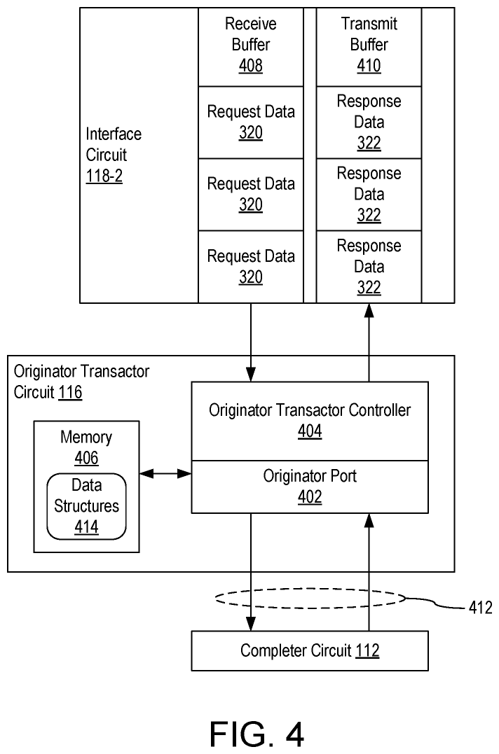

FIG. 4 illustrates an example implementation of originator transactor circuit 116 and interface circuit 118-2. In the example of FIG. 4, originator transactor circuit 116 includes an originator port 402, an originator transactor controller 404, and a memory 406.

Originator transactor circuit 116 is capable of receiving request data via transceiver circuits 120 and interface circuit 118-2. Originator transactor controller 404 receives request data and stores the request data in memory 406 as a data structure illustrated as data structures 414. Originator transactor controller 404 reads the request data from memory 406 and converts or reconstructs the request data as a request formatted as RTL signals 412 using originator port 402. Originator port 402 is a port that supports RTL signaling corresponding to the communication protocol used by completer circuit 112 (e.g., the selected communication protocol). The request, in the form of RTL signals 412, may be conveyed to completer circuit 112 using the selected communication protocol.

Originator port 402 receives a response from completer circuit 112, e.g., memory controller 226, as one or more transfers received over one or more clock cycles via originator port 402. In the example of FIG. 4, a response is received by originator port 402 as RTL signals 412 using the selected communication protocol. Originator transactor controller 404 translates the received response into response data that is stored in memory 406 as a data structure (e.g., shown as data structures 414). Each request and each response may be stored as a distinct data structure. For example, in the case of a read response, multiple transfers of data may be received via originator port 402 over a plurality of consecutive clock cycles as RTL signals 412. Originator transactor controller 404 is capable of concatenating each respective transfer into response data that may be stored in memory 406 as a data structure (e.g., a single array).

In the example of FIG. 4, originator transactor circuit 116 may be configured to provide a standardized streaming interface to interface circuit 118-2.

In the example of FIG. 4, interface circuit 118-2 includes a plurality of buffer memories. As illustrated, interface circuit 118-2 includes a receive buffer 408 and a transmit buffer 410. Receive buffer 408 is capable of storing received request data 320 corresponding to the plurality of requests from originator circuit 108. Receive buffer 408 stores request data 320 before streaming to originator transactor circuit 116. Transmit buffer 410 is capable of storing response data 322 corresponding to a plurality of different responses. Transmit buffer 410 stores response data 322 prior to conveying the response data 322 to transceiver circuit 120-2. In one or more example implementations, receive buffer 408 and transmit buffer 410 each may be implemented as a FIFO memory.

In the example of FIG. 4, to synchronize data between the transceiver clock domain and the originator circuit clock domain, the data port of receive buffer 408 coupled to originator transactor circuit 116 and the data port of transmit buffer 410 coupled to originator transactor circuit 116 operate in the completer clock domain while the data port of receive buffer 408 coupled to transceiver circuit 120-2 and the data port of transmit buffer 410 coupled to transceiver circuit 120-2 operate in the transceiver clock domain.

Referring to the examples of FIGS. 3 and 4, in one or more other example implementations, each of memories 306, 406 may be divided, partitioned, or implemented as separate memories corresponding to a transmit buffer and a receive buffer. The transmit buffer of memory 306 may feed transmit buffer 308, while receive buffer 310 may feed the receive buffer of memory 306. Similarly, the receive buffer of memory 406 may be fed by receive buffer 408 while the transmit buffer of memory 406 feeds transmit buffer 410.

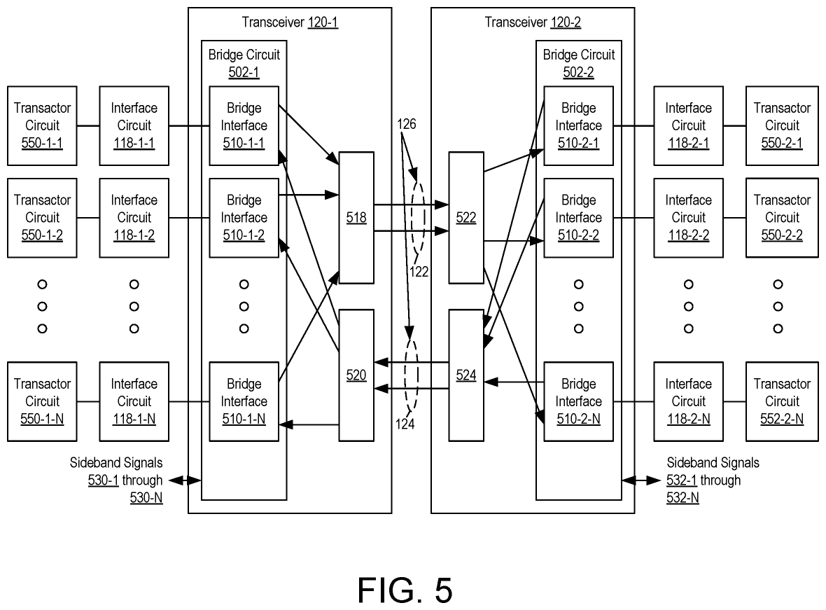

FIG. 5 is a block diagram illustrating certain operative features of system 100. FIG. 5 illustrates an example where a plurality of transactor pairs are coupled through the pair of transceiver circuits 120. In the example, pairs of transactor circuits 550 are shown. Each pair of transactor circuits may be formed of a transactor circuit 550-1 and a corresponding transactor circuit 550-2 (e.g., 550-1-1 and 550-1-2). A pair of transactor circuits includes a pair of complementary transactor circuits, e.g., an originator transactor circuit and a completer transactor circuit.

In some cases, the originator transactor circuit is illustrated as a transactor circuit 550-1 while the completer transactor circuit is illustrated as a transactor circuit 550-2. In other cases, the completer transactor circuit is illustrated as a transactor circuit 550-1 while the originator transactor circuit is illustrated as a transactor circuit 550-2. Thus, transactor circuits 550-1 may represent originator circuits, transactor circuits, or a combination thereof. Similarly, transactor circuits 550-2 may represent the complementary transactor circuits for each respective transactor circuit pair. For purposes of illustration, communication buses between transactor circuits and interface circuits on either side of the pair of transceiver circuits 120 are not shown.

Each transactor circuit 550 is coupled to a corresponding and respective interface circuit 118. FIG. 5 illustrates that each transceiver circuit 120 is capable of coupling to a plurality of transactor circuits by way of a bridge circuit that includes a plurality of bridge interfaces. For example, transceiver circuit 120-1 includes a bridge circuit 502-1 having a plurality of bridge interfaces 510-1. Transceiver circuit 120-1 also includes a multi-gigabit (MG) transmitter 518 and an MG receiver 520. Transceiver circuit 120-2 includes a bridge circuit 502-1 having a plurality of bridge interfaces 510-2. Transceiver circuit 120-2 also includes an MG receiver 522 and an MG transmitter 524.

In the example of FIG. 5, each bridge circuit 502 is capable of coupling to circuitry, e.g., a partition, implemented in the same IC as the bridge circuit. The number of bridge interfaces 510, e.g., the N bridge interfaces, included in each respective bridge circuit 502 determines the number of transactor circuits 550 to which the bridge circuit is able to connect. Each bridge interface 510-1 connects to MG transmitter 518 and to MG receiver 520. Similarly, each bridge interface 510-2 connects to MG receiver 522 and to MG transmitter 524. In the example, the value of N may be set to a maximum of 16. Thus, up to 16 transactor circuit pairs may couple through respective interface circuits 118 to a single pair of transceiver circuits 120. The inventive arrangements disclosed herein are not intended to be limited by the particular number of pairs of transactor circuits that may connect to a given pair of transceiver circuits 120.

In the example of FIG. 5, each bridge interface 510 is capable of performing packetization and/or depacketization. Data packetized by a bridge circuit may be conveyed to the MG transmitter coupled thereto. For example, data received by a bridge interface 510-1 from an interface circuit 118-1 may be packetized and conveyed to MG transmitter 518 for conveyance over transmit link 122 to MG receiver 522. Data received by MG receiver 520 via receive link 124 may be depacketized by a bridge interface 510-1 and conveyed to a corresponding interface circuit 118-1.

Similarly, data received by MG receiver 522 via transmit link 122 may be depacketized by a bridge interface 510-2 and conveyed to a corresponding interface circuit 118-2. Data received by a bridge interface 510-2 from an interface circuit 118-2 may be packetized and conveyed to MG transmitter 524 for conveyance over receive link 124 to MG receiver 520.

MG transmitter 518 is capable of serializing data received from bridge interfaces 510-1 and outputting serialized packets over transmit link 122. Transmit link 122 may be a differential serial output, e.g., a differential pair. In one or more example implementations, MG transmitter 518 is capable of outputting data using a selected type of encoding. An example encoding that may be used by MG transmitter 518 is NRZ encoding. MG receiver 522 is capable of receiving packets over transmit link 122, deserializing the received packets, and providing the packets to appropriate bridge interfaces 510-2. MG transmitter 524 and MG receiver 520 are capable of operating similar to, or the same as, MG transmitter 518 and MG receiver 522, respectively albeit over receive link 124.

It should be appreciated that the terms transmit and receive in reference to the serial links are used for purposes of illustration and to differentiate one channel from another. Each such channel may convey request and/or response data for a variety of transactor circuits.

In the example of FIG. 5, bridge circuit 502-1 receives and/or drives one or more sideband signals 530. Bridge circuit 502-2 receives and/or drives one or more sideband signals 532. In one aspect, sideband signals are signals that are associated with one or more of the pairs of transactor circuits 550, but that are not defined by the particular communication protocol utilized by the pair of transactor circuits 550. Examples of sideband signals 530, 532 include interrupt signals and low bandwidth signals. Sideband signals 530 and sideband signals 532 correspond to signals obtained from a transactor circuit 550 that are conveyed to a respective paired transactor circuit 550.

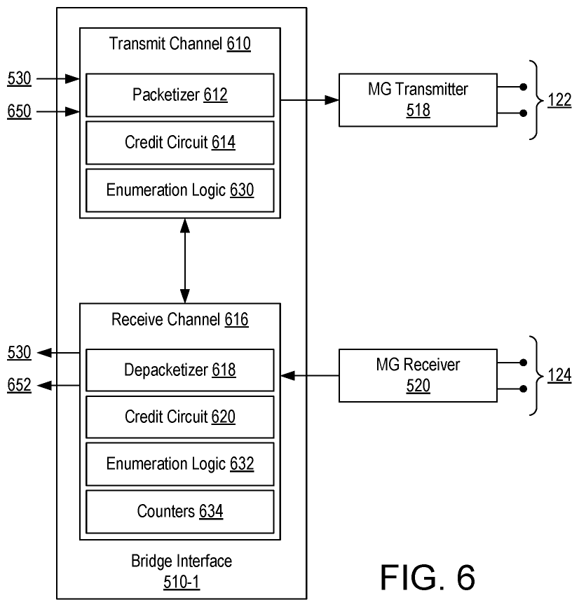

FIG. 6 illustrates a more detailed example implementation of a bridge interface 510-1 of FIG. 5. It should be appreciated that the example of FIG. 6 also may be used to implement bridge interfaces 510-2. In the example of FIG. 6, bridge interface 510-1 is capable of performing operations such as data packetization and depacketization. As shown, bridge interface 510-1 includes a transmit channel 610 and a receive channel 616. Transmit channel 610 includes a packetizer 612, a credit circuit 614, and enumeration logic 630. Receive channel 616 includes a depacketizer 618, a credit circuit 620, enumeration logic 632, and a plurality of counters 634.

In one aspect, data from MG receiver 520 may be conveyed to each bridge interface 510-1 with each receive channel 616 being configured to detect the packets directed to that particular receive channel (e.g., using a channel number included in the packets that identifies a particular channel and, as such, a particular transactor circuit associated with that channel).

Referring to transmit channel 610, packetizer 612 is capable of generating packets of data generated from data 650 received from an interface circuit 118-1 (e.g., from transmit buffer 308). Packetizer 612 may convey generated packets of data to MG transmitter 518 for transmission over transmit link 122. Credit circuit 614 is capable of regulating the flow of packets sent from packetizer 612 based on an amount of credit received via credit circuit 620 in receive channel 616. Referring to receive channel 616, depacketizer 618 is capable of depacketizing packets received from MG receiver 520. That is, depacketizer 618 is capable of extracting the data from the packets and providing the extracted data 652 to interface circuit 118-1 (e.g., to receive buffer 310).

Data transmitted via transmit channel 610 via MG transmitter 518 is received by MG receiver 522, depacketized by a bridge interface 510-2, clock domain converted by the corresponding interface circuit 118-2, and reconstructed by the transactor circuit 550-2. The data will have the original bit-width, e.g., the same as that of the original request and/or response.

Data received via MG receiver 520 via receive link 124 may be depacketized by bridge interface 510-1, clock domain converted by the corresponding interface circuit 118-1, and reconstructed by the corresponding transactor circuit 550-1.

In one or more other example implementations, streaming data conveyance may be disabled while maintaining enablement (e.g., operation) of sideband communications. In such cases, sideband signals 530 and/or 532 may be conveyed over communication links 126 while other data (e.g., request data and/or response data) is not.

In the example, the sideband signals from a particular transactor circuit 550 are provided to the bridge interface 510 corresponding to that particular transactor circuit. For example, sideband signals from transactor circuit 550-1-1 are conveyed from transactor circuit 550-1-1 to bridge interface 510-1-1 (e.g., to packetizer 612). Similarly, sideband signals directed to transactor circuit 550-1-1 may be provided from bridge interface 510-1-1 (e.g., from depacketizer 618) to transactor circuit 550-1-1. Likewise, sideband signals from transactor circuit 550-2-1 are conveyed to bridge interface 510-2-1. Sideband signals directed to transactor circuit 550-2-1 may be provided from bridge interface 510-2-1 to transactor circuit 550-2-1.

In the examples, the sideband signals are implemented as low bandwidth signals that bypass credit check (credit circuits 614, 620) and packetization circuitry (packetizer 612, depacketizer 618). The sideband signals may be directly transmitted over the transmit link or receive link. In one or more examples, sideband signals are transmitted periodically. For example, sideband signals may be transmitted every M (where M is an integer) number of transmission cycles. As an illustrative and non-limiting example, M may be set to 512 transmission cycles. For purposes of illustration and not limitation, for a line rate of 10.3125 Gbps (10312.5 Mbps/512==˜ 20 MHz), all of the transitions of any sideband signal having a bandwidth of less than 20 MHz can be captured and transmitted over a transmit or receive link. In the example of FIG. 6, the architecture of a bridge interface is illustrated. It should be appreciated that in the case of a bridge circuit, multiple instances of the bridge interface, e.g., one for each transactor circuit coupled to the bridge circuit, may be included. Each such instance will connect to an MG transmitter and an MG receiver. That is, with N bridge interfaces, MG transmitter 518 will have an incoming data path from each of the N bridge interfaces. MG transmitter 518 may include arbitration logic for selecting data from the N transmit channels for serialization and transmission. MG receiver 520 will have an outgoing data path to each of the N bridge interfaces. As noted, MG receiver 520 may broadcast the data to each of the N bridge interfaces where each of the N bridge interfaces only accepts data intended for that bridge interface.

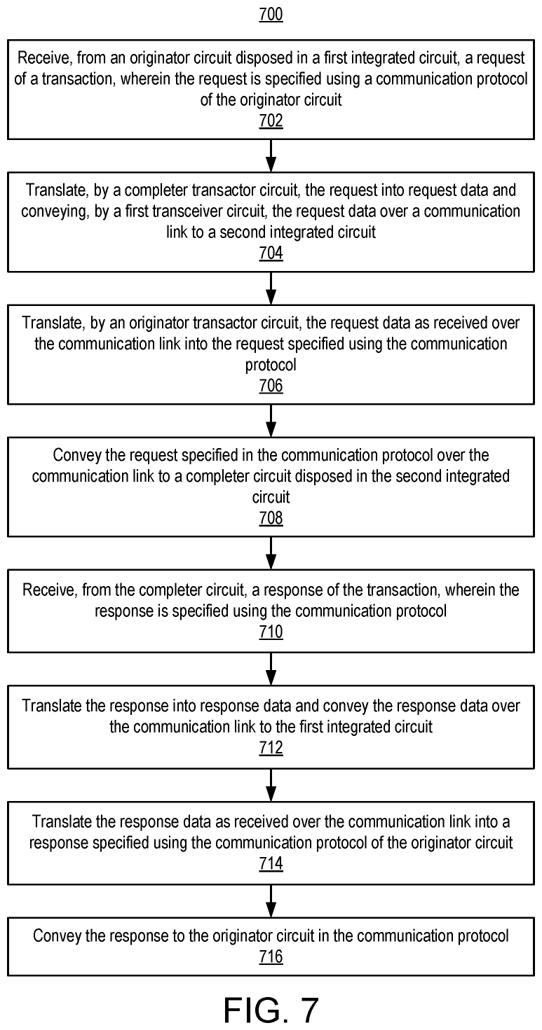

FIG. 7 illustrates an example method 700 of operation of a system using the transactor-based framework described within this disclosure. Method 700 may be implemented by a system implementing the architecture illustrated in FIG. 1.

In block 702, a request of a transaction is received from originator circuit 108 disposed in a first IC (e.g., IC 102-1) of the system. The request is specified using a communication protocol of originator circuit 108. As discussed, the request may be specified as RTL signals. The request may be received by completer transactor circuit 114. In one or more examples, the request is comprised of a plurality of transfers and completer transactor circuit 114 generates the request data by concatenating each of the plurality of transfers.

In block 704, the request may be translated, by completer transactor circuit 114, into request data. The request data may be conveyed by a first transceiver circuit (e.g., transceiver circuit 120-1) over communication link 126 (e.g., transmit link 122) to a second integrated circuit (e.g., IC 102-2). Communication link 126 operates asynchronously to originator circuit 108 and completer circuit 112.

In one or more examples, the request data is conveyed over the communication link in response to translating an entirety of the plurality of transfers of the request into the request data and determining that a transceiver circuit of the first integrated circuit (e.g., transceiver circuit 120-1) is ready to accept the request data for conveyance over the communication link.

In one or more examples, prior to the conveying the request data over the communication link to the second integrated circuit, the request data is synchronized from an originator clock domain to a transceiver clock domain.

In block 706, the request data, as received over the communication link, may be translated by originator transactor circuit 116 into the request specified using the communication protocol. That is, originator transactor circuit 116 may reconstruct the request specified in RTL signals using the communication protocol from the request data. In block 708, the request, as specified in the communication protocol, may be conveyed by originator transactor circuit 116 to completer circuit 112 disposed in the second integrated circuit.

In one or more examples, subsequent to the conveying the request data over the communication link to the second integrated circuit and prior to the translating the request data as received over the communication link into the request specified using the communication protocol, the request data is synchronized from the transceiver clock domain to a completer clock domain.

In block 710, a response of the transaction is received from completer circuit 112. The response may be received by originator transactor circuit 116. The response may be specified in the communication protocol. For example, the response may be specified as RTL signals formatted in the communication protocol. In block 712, the response is translated, e.g., by originator transactor circuit 116, into response data and conveyed over communication link 126 to the first integrated circuit. In block 714, the response data, as received over the communication link, is translated, e.g., by completer transactor circuit 114, into a response specified using the communication protocol of originator circuit 108. For example, completer transactor circuit 114 reconstructs the response in RTL signals formatted using the communication protocol from the response data. In block 716, the response is conveyed by completer transactor circuit 114 to originator circuit 108 in the communication protocol.

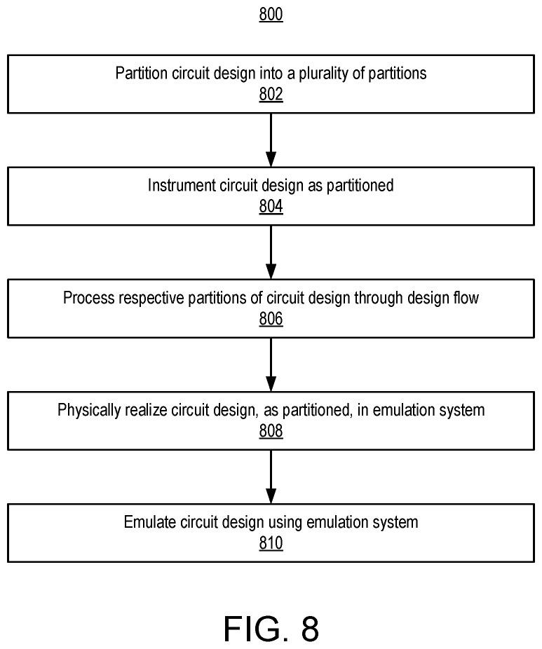

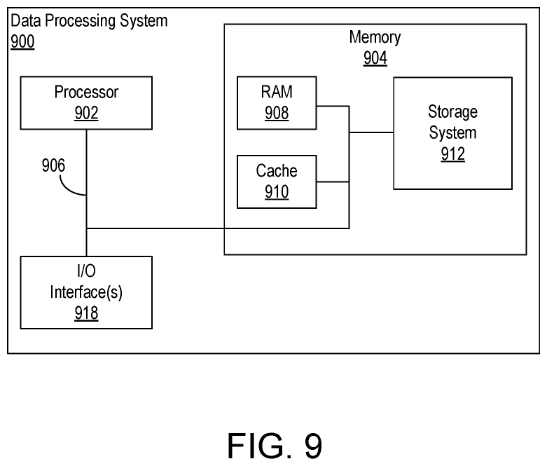

FIG. 8 illustrates an example method 800 of implementing a circuit design in an emulation system that includes a plurality of ICs. Method 800 illustrates an automatic technique (e.g., without manual intervention) for instrumenting transactors into a circuit design for implementation in an emulation system. Method 800 may be performed or executed by a data processing system (system) to implement the circuit design within an emulation system. An example of a data processing system is described herein in connection with FIG. 9. An example of an emulation system is described herein in connection with FIG. 1.

In block 802, the system is capable of partitioning circuit design 106 into a plurality of different partitions. In one or more examples, the system is capable of automatically partitioning circuit design 106 at synchronous communication protocol boundaries. For example, the system is capable of partitioning circuit design 106 at such detected bus boundaries that separate an originator circuit and a completer circuit pair. In one or more examples, the system may receive user input(s) that select or designate the particular points (e.g., buses and/or nets) within circuit design 106 that are to be the cut or partition points between partitions.

In block 804, the system is capable of instrumenting circuit design 106 as partitioned. The instrumenting may include inserting a completer transactor circuit within the partition that includes the originator circuit, inserting an originator transactor circuit within the partition including the completer circuit. The system is further capable of inserting a transceiver circuit 120 within each of the partitions and respective interface circuits 118. The system further couples, or connects, the inserted circuit blocks with one another and to the user circuitry as described throughout this disclosure. The instrumentation described allows each transactor circuit pair to run or pass the data traffic described herein over the communication links established by the transceiver pairs.

In block 806, the system is capable of processing each of the respective partitions of circuit design 106 through a design flow (e.g., synthesis, placement, routing, configuration data generation, and/or any other types of optimizations). The system may process each partition through the design flow serially or in parallel. As noted, each partition may be processed through the design flow independently of the other partitions. Further, in terms of parallel processing, each partition may be processed through the design flow using a separate thread of execution or using a separate data processing system. Thus, configuration data may be generated on a per-partition basis.

In block 808, the system is capable of physically realizing the circuit design, as partitioned, in the emulation system. For example, the system is capable of implementing each partition in a different IC of the emulation system. The system may load the configuration data for each partition into the respective IC of the emulation system used for the partition. Those ICs that implement partitions in communication with one another will have physical communication links as described coupling transceiver circuits 120.

In block 810, circuit design 106 is emulated by the emulation system. The transactor framework described herein as implemented in circuit design 106 and physically realized in the emulation system is capable of tunneling serialized data over the communication links between transceiver circuits 120 to effectuate originator circuit-completer circuit communication between ICs.

FIG. 9 illustrates an example implementation of a data processing system 900. As defined herein, the term “data processing system” means one or more hardware systems configured to process data, each hardware system including at least one processor and memory, wherein the processor is programmed with computer-readable instructions that, upon execution, initiate operations. Data processing system 900 can include a processor 902, a memory 904, and a bus 906 that couples various system components including memory 904 to processor 902.

Processor 902 may be implemented as one or more processors. In an example, processor 902 is implemented as a central processing unit (CPU). Processor 902 may be implemented as one or more circuits, e.g., hardware, capable of carrying out instructions contained in program code. The circuit may be an integrated circuit or embedded in an integrated circuit. Processor 902 may be implemented using a complex instruction set computer architecture (CISC), a reduced instruction set computer architecture (RISC), a vector processing architecture, or other known architectures. Example processors include, but are not limited to, processors having an x86 type of architecture (IA-32, IA-64, etc.), Power Architecture, ARM processors, and the like.

Bus 906 represents one or more of any of a variety of communication bus structures. By way of example, and not limitation, bus 906 may be implemented as a Peripheral Component Interconnect Express (PCIe) bus. Data processing system 900 typically includes a variety of computer system readable media. Such media may include computer-readable volatile and non-volatile media and computer-readable removable and non-removable media.

Memory 904 can include computer-readable media in the form of volatile memory, such as random-access memory (RAM) 908 and/or cache memory 910. Data processing system 900 also can include other removable/non-removable, volatile/non-volatile computer storage media. By way of example, storage system 912 can be provided for reading from and writing to a non-removable, non-volatile magnetic and/or solid-state media (not shown and typically called a “hard drive”), which may be included in storage system 912. Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 906 by one or more data media interfaces. Memory 904 is an example of at least one computer program product.

Memory 904 is capable of storing computer-readable program instructions that are executable by processor 902. For example, the computer-readable program instructions can include an operating system, one or more application programs, other program code, and program data. The computer-readable program instructions may implement an Electronic Design Automation (EDA) system that is capable of performing the various operations described herein that are attributable to a data processing system. For example, the computer-readable program instructions may be executable to implement a design flow as described and/or load configuration data into the emulation system. The emulation system may be coupled to data processing system 900.

Processor 902, in executing the computer-readable program instructions, is capable of performing the various operations described herein that are attributable to a computer. It should be appreciated that data items used, generated, and/or operated upon by data processing system 900 are functional data structures that impart functionality when employed by data processing system 900. As defined within this disclosure, the term “data structure” means a physical implementation of a data model's organization of data within a physical memory. As such, a data structure is formed of specific electrical or magnetic structural elements in a memory. A data structure imposes physical organization on the data stored in the memory as used by an application program executed using a processor.

Data processing system 900 may include one or more Input/Output (I/O) interfaces 918 communicatively linked to bus 906. I/O interface(s) 918 allow data processing system 900 to communicate with one or more external devices and/or communicate over one or more networks such as a local area network (LAN), a wide area network (WAN), and/or a public network (e.g., the Internet). Examples of I/O interfaces 918 may include, but are not limited to, network cards, modems, network adapters, hardware controllers, etc. Examples of external devices also may include devices that allow a user to interact with data processing system 900 (e.g., a display, a keyboard, and/or a pointing device) and/or other devices such as accelerator card and/or emulation system.

Data processing system 900 is only one example implementation. Data processing system 900 can be practiced as a standalone device (e.g., as a user computing device or a server, as a bare metal server), in a cluster (e.g., two or more interconnected computers), or in a distributed cloud computing environment (e.g., as a cloud computing node) where tasks are performed by remote processing devices that are linked through a communications network. In a distributed cloud computing environment, program modules may be located in both local and remote computer system storage media including memory storage devices.

As used herein, the term “cloud computing” refers to a computing model that facilitates convenient, on-demand network access to a shared pool of configurable computing resources such as networks, servers, storage, applications, ICs (e.g., programmable ICs) and/or services. These computing resources may be rapidly provisioned and released with minimal management effort or service provider interaction. Cloud computing promotes availability and may be characterized by on-demand self-service, broad network access, resource pooling, rapid elasticity, and measured service.

The example of FIG. 9 is not intended to suggest any limitation as to the scope of use or functionality of example implementations described herein. Data processing system 900 is an example of computer hardware that is capable of performing the various operations described within this disclosure. In this regard, data processing system 900 may include fewer components than shown or additional components not illustrated in FIG. 9 depending upon the particular type of device and/or system that is implemented. The particular operating system and/or application(s) included may vary according to device and/or system type as may the types of I/O devices included. Further, one or more of the illustrative components may be incorporated into, or otherwise form a portion of, another component. For example, a processor may include at least some memory.

The terminology used herein is for the purpose of describing particular embodiments only and is not intended to be limiting. Notwithstanding, several definitions that apply throughout this document are expressly defined as follows.

As defined herein, the singular forms “a,” “an,” and “the” are intended to include the plural forms as well, unless the context clearly indicates otherwise.

As defined herein, the term “approximately” means nearly correct or exact, close in value or amount but not precise. For example, the term “approximately” may mean that the recited characteristic, parameter, or value is within a predetermined amount of the exact characteristic, parameter, or value.

As defined herein, the terms “at least one,” “one or more,” and “and/or,” are open-ended expressions that are both conjunctive and disjunctive in operation unless explicitly stated otherwise. For example, each of the expressions “at least one of A, B, and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

As defined herein, the term “automatically” means without human intervention.

As defined herein, the term “computer-readable storage medium” means a storage medium that contains or stores program instructions for use by or in connection with an instruction execution system, apparatus, or device. As defined herein, a “computer-readable storage medium” is not a transitory, propagating signal per se. The various forms of memory, as described herein, are examples of computer-readable storage media. A non-exhaustive list of examples of computer-readable storage media include an electronic storage device, a magnetic storage device, an optical storage device, an electromagnetic storage device, a semiconductor storage device, or any suitable combination of the foregoing. A non-exhaustive list of more specific examples of a computer-readable storage medium may include: a portable computer diskette, a hard disk, a RAM, a read-only memory (ROM), an erasable programmable read-only memory (EPROM or Flash memory), an electronically erasable programmable read-only memory (EEPROM), a static random-access memory (SRAM), a portable compact disc read-only memory (CD-ROM), a digital versatile disk (DVD), a memory stick, a floppy disk, or the like.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context.

As defined herein, the term “responsive to” and similar language as described above, e.g., “if,” “when,” or “upon,” means responding or reacting readily to an action or event. The response or reaction is performed automatically. Thus, if a second action is performed “responsive to” a first action, there is a causal relationship between an occurrence of the first action and an occurrence of the second action. The term “responsive to” indicates the causal relationship.

As defined herein, the terms “individual” and “user” each refer to a human being.

As defined herein, the terms “one embodiment,” “an embodiment,” “in one or more embodiments,” “in particular embodiments,” or similar language mean that a particular feature, structure, or characteristic described in connection with the embodiment is included in at least one embodiment described within this disclosure. Thus, appearances of the aforementioned phrases and/or similar language throughout this disclosure may, but do not necessarily, all refer to the same embodiment.

As defined herein, the term “real-time” means a level of processing responsiveness that a user or system senses as sufficiently immediate for a particular process or determination to be made, or that enables the processor to keep up with some external process.

As defined herein, the term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

The terms first, second, etc. may be used herein to describe various elements. These elements should not be limited by these terms, as these terms are only used to distinguish one element from another unless stated otherwise or the context clearly indicates otherwise.

In some alternative implementations, the operations noted in the blocks may occur out of the order noted in the figures. For example, two blocks shown in succession may be executed substantially concurrently, or the blocks may sometimes be executed in the reverse order, depending upon the functionality involved. In other examples, blocks may be performed generally in increasing numeric order while in still other examples, one or more blocks may be performed in varying order with the results being stored and utilized in subsequent or other blocks that do not immediately follow. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A circuit design emulation system having a plurality of integrated circuits, the circuit design emulation system comprising:
a first integrated circuit including:
an originator circuit configured to issue a request of a transaction directed to a completer circuit, wherein the request is specified in a communication protocol;
a completer transactor circuit coupled to the originator circuit and configured to translate the request into request data;
a first interface circuit configured to synchronize the request data from an originator clock domain to a transceiver clock domain operating at a higher frequency than the originator clock domain; and
a first transceiver circuit configured to convey the request data over a communication link that operates asynchronously to the originator clock domain.

2. The circuit design emulation system of claim 1, wherein the first interface circuit comprises a transmit first-in-first-out memory configured to synchronize the request data and a receive first-in-first-out memory configured to synchronize response data received in response to the request.

3. The circuit design emulation system of claim 1, wherein the first transceiver circuit is configured to stream the request data over the communication link.

4. The circuit design emulation system of claim 3, wherein the communication link is a serial communication link.

5. The circuit design emulation system of claim 1, wherein the request is comprised of a plurality of transfers and the completer transactor circuit generates the request data by concatenating each transfer of the plurality of transfers.

6. The circuit design emulation system of claim 5, wherein the request data is conveyed over the communication link in response to translating an entirety of the request into the request data and determining that the first transceiver circuit is ready to accept the request data for conveyance over the communication link.

7. The circuit design emulation system of claim 1, further comprising:
a second integrated circuit including:
a second transceiver circuit configured to receive the request data over the communication link;
a second interface circuit configured to synchronize the request data from the transceiver clock domain to a completer clock domain operating at a lower frequency than the transceiver clock domain;
an originator transactor circuit coupled to the second interface circuit and configured to translate the request data into the request specified in the communication protocol; and
wherein the completer circuit is configured to generate a response to the request, wherein the response is specified in the communication protocol.

8. The circuit design emulation system of claim 7, wherein:
the originator transactor circuit is configured to convert the response specified in the communication protocol into response data;
the second interface circuit is configured to synchronize the response data from the completer clock domain to the transceiver clock domain; and
the second transceiver circuit is configured to send the response data, as synchronized, over the communication link.

9. The circuit design emulation system of claim 8, wherein the second interface circuit comprises a receive first-in-first-out memory configured to synchronize the request data and a transmit first-in-first-out memory configured to synchronize the response data.

10. The circuit design emulation system of claim 8, wherein the response data is conveyed over the communication link in response to translating an entirety of a plurality of transfers of the response into the response data and determining that the second transceiver circuit is ready to accept the response data for conveyance over the communication link.

11. The circuit design emulation system of claim 8, wherein:
the first transceiver circuit is configured to receive the response data via the communication link;
the first interface circuit is configured to synchronize the response data from the transceiver clock domain to the originator clock domain; and
the completer transactor circuit is configured to translate the response data into the response specified using the communication protocol and provide the response as translated to the originator circuit.

12. The circuit design emulation system of claim 1, wherein the circuit design is subdivided into a plurality of partitions, each partition implemented in a different integrated circuit of the plurality of integrated circuits by operation of the completer transactor circuit and an originator transactor circuit disposed on opposite ends of the communication link.

13. The circuit design emulation system of claim 12, wherein a first partition of the plurality of partitions and a second partition of the plurality of partitions are separated along a boundary determined based on inclusion of a communication bus within a signal path coupling the originator circuit and the completer circuit.

14. A method of emulating a circuit design, comprising:
receiving, from an originator circuit disposed in a first integrated circuit, a request of a transaction, wherein the request is specified using a communication protocol of the originator circuit;
translating, by a completer transactor circuit, the request into request data and conveying, by a first transceiver circuit, the request data over a communication link to a second integrated circuit;
translating, by an originator transactor circuit, the request data as received over the communication link into the request specified using the communication protocol; and
conveying the request specified in the communication protocol over the communication link to a completer circuit disposed in the second integrated circuit;
wherein the communication link operates asynchronously to the originator circuit and to the completer circuit.

15. The method of claim 14, wherein the request is comprised of a plurality of transfers and the completer transactor circuit generates the request data by concatenating each transfer of the plurality of transfers.

16. The method of claim 15, wherein the request data is conveyed over the communication link in response to translating an entirety of the plurality of transfers of the request into the request data and determining that a transceiver circuit of the first integrated circuit is ready to accept the request data for conveyance over the communication link.

17. The method of claim 14, further comprising:
prior to the conveying the request data over the communication link to the second integrated circuit, synchronizing the request data from an originator clock domain to a transceiver clock domain.

18. The method of claim 17, further comprising:
subsequent to the conveying the request data over the communication link to the second integrated circuit and prior to the translating the request data as received over the communication link into the request specified using the communication protocol, synchronizing the request data from the transceiver clock domain to a completer clock domain.

19. The method of claim 14, further comprising:
receiving, from the completer circuit, a response of the transaction, wherein the response is specified using the communication protocol;
translating the response into response data and conveying the response data over the communication link to the first integrated circuit;
translating the response data as received over the communication link into a response specified using the communication protocol of the originator circuit; and
conveying the response to the originator circuit in the communication protocol.

20. The method of claim 19, wherein the response is comprised of a plurality of transfers and the originator transactor circuit generates the response data by concatenating each transfer of the plurality of transfers.
